(19) United States
(12) Patent Application Publication
(10) Pub. No.: US 2016/0034982 A1
(43) Pub. Date: Feb. 4, 2016

(54) Business Methods for Providing an Off-Label Medical Use Portal

(71) Applicant: Moshe ROGOSNITZKY, Telz Stone (IL)

(72) Inventor: Moshe Rogosnitzky, Telz Stone (IL)

(21) Appl. No.: 14/777,491

(22) PCT Filed: Mar. 17, 2014
(86) PCT No.: PCT/IB14/59906

§ 371 Date: Sep. 15, 2015

Related U.S. Application Data
(60) Provisional application No. 61/787,493, filed on Mar. 15, 2013.

(51) Int. Cl. G06Q 30/02; G06F 17/30

(52) U.S. Cl. CPC G06Q 30/0282; G06F 17/30557; G06Q 50/22

(57) ABSTRACT

An off-label medical use portal, including a centralized database encoded on a computer readable-medium, a collecting mechanism for collecting information regarding off-label medical use, a peer-review mechanism for vetting collected information, and an access mechanism for providing access to unvetted and vetted information in electronic communication with the centralized database. A method of using the off-label medical use portal by submitting publications about off-label medical use to the portal, peer-reviewing the publications, and providing access to non-peer-reviewed and peer-reviewed information and publications to interested individuals.

### BACKGROUND OF THE INVENTION

1. Technical Field

The present invention relates to off-label use of medication and medical devices. More specifically, the present invention relates to business methods and portal interfaces to aid in off label use.

2. Background Art

The submission, review, acceptance, and publication of medical research manuscripts have traditionally been lengthy and time-consuming processes, taking many months, sometimes years, to enable publication of a single manuscript. With the advent of the Internet, the time needed to submit manuscripts to publishers, and the resulting review process, have been reduced significantly. This has led to a continually increasing number of medical research manuscripts being published. At present, an excess of two million medical manuscripts are estimated to be published annually.

Medical research encompasses a broad range of areas and topics that include amongst other modalities, methods of treating diseases using pharmaceutical or medical device interventions. Medical research related to pharmaceutical or medical device interventions is usually published either in a journal relating to a given disease that is being treated, in a journal that focuses on pharmacology in general, or on the different classes of pharmaceutical groups of treatments (such as anti-microbials, anti-neoplastics, immune-modulators, and cytokines).

Physicians as well as practitioners involved in pharmaceutical development typically subscribe to a number of journals in order to learn about new treatment options for diseases of interest. The cost of subscribing to a medical journal is quite high. It has been estimated that subscribing to all biomedical journals would cost in excess of $50 million per year. For this reason, it is necessary for interested parties to determine a narrow range of journals for subscription.

From the publishing aspect, physicians who desire to publish new findings relating to a new drug use (off-label or repurposing) typically submit manuscripts to either a journal in the relevant medical specialty, or to a journal focusing on the class of medical intervention involved. Manuscript acceptance rates for articles in peer-reviewed journals vary widely and can be as low as 5% for high-impact journals (such as The Lancet or The New England Journal of Medicine). A situation arises in which it may take as much as three years to find a venue for publication of a manuscript. In many cases, authors give up after several unsuccessful attempts, resulting in their findings never being published.

Off-label medical intervention, also known as unapproved (new) use of approved drugs or cleared medical devices (i.e., using a drug or device for a non-indicated disorder, or non-indicated age group, or in a modified dosage form, or in a modified delivery method, or modified delivery route) relates to a manner of using such intervention for a purpose that is not specified in a regulatory agency's approved packaging label or insert. It is also known as ex-indication use (hereinafter referred to as off-label medical use which is intended to include medical devices and medical diagnostics in addition to pharmaceuticals). In most countries worldwide, prescribing medications for off-label uses is considered legal by regulatory agencies, including the FDA. In the US, off-label use is estimated to account for >40% of all drug use. While individual physicians can decide to use medications for off-label uses, it is illegal in the US for a drug company to actually promote the off-label use to medical prescribers. Drug and medical device companies are permitted to provide medical prescribers with copies of publications concerning off-label uses so long as they have been subject to peer-review and that the drug or medical device company does not promote these uses. Recently, the FDA proposed guidance for industry entitled: “Good Reprint Practices for the Distribution of Medical Journal Articles and Medical or Scientific Reference Publications on Unapproved New Uses of Approved Drugs and Approved or Cleared Medical Devices”. Because of the fine line between provision of information and promotion, many drug companies have been required to pay large settlements (up to $2.3 billion) resulting from illegal promotion of off-label uses. Therefore, while it would help their sales revenues, there is a great risk and disincentive for drug companies to provide information regarding off-label use, and this makes it more difficult for relevant information to get to medical prescribers.

Medical prescribers are also exposed to greater liability and sanctions for prescribing an off-label use when state medical boards or societies have reason to bring action against a prescriber. While prescribing a labeled use (or indicated use) typically shields a prescriber from responsibility for adverse effects, prescribing an off-label use leaves a prescriber much more vulnerable in the event that adverse effects arise. It is therefore critically important for prescribers contemplating off-label use of medications to have well-substantiated, published studies backing a decision to prescribe a particular medication for a non-approved use in order to guard against liability for unjustified use of medications.

While many drugs prescribed for off-label uses no longer enjoy patent protection, and are therefore not actively promoted by pharmaceutical companies, a sizeable number of patents are in force for off-label uses. However, the market size for newly-discovered, off-label use is not always sufficiently large to justify obtaining regulatory approval for a new indication by a patent holder. While the cost of such an approval process is considerably cheaper than bringing a new drug entity to market (which can reach over one billion USD), it is still a significant expense that can cost tens of millions of dollars. Actively promoting a drug for off-label use is considered illegal by regulatory authorities due to the perception that such activity circumvents the lengthy and thorough procedures required to obtain regulatory approval for such new indications.

Therefore, given the practical limitations to a broad journal subscription base and a promising manuscript publication channel described above, a physician wishing to learn specifically about off-label uses for existing drugs is left without an adequate marketplace of readily-accessible, relevant information. In contrast, information for approved uses is made widely available by pharmaceutical companies. Moreover, easy access to such information can provide cost-effective, fast-track commercialization opportunities for new off-label uses of off-patent drugs by obtaining approval for the new use.

Furthermore, practitioners involved in new drug development, either in pharmaceutical companies or biotech startups, have a compelling need to learn about newly-discovered indications for existing drugs at the earliest stage possible. Such newly discovered uses often have been patented as secondary-use patents, providing attractive protection for industry to license the intellectual property. Substantial resources (time, effort, and funds) are utilized in order to obtain such valuable information. To be all encompassing, interested parties would have to read every new drug-related article, and then check the respective regulatory agency's database to see if the article is referring to an off-label use. This naturally slows down innovation and commercialization efforts to bring new therapeutic avenues to market. However, while there is a desire to learn about off-label uses at the earliest stage possible, early publication of off-label uses can lead to the loss of intellectual property rights.

It should also be noted that reports about new off-label uses face a significant challenge in finding a venue for publication due to the fact that 59% of such innovations are incidentally discovered by practicing physicians in the field. Such findings are either in the format of case reports, case series, open-label trials, or preliminary small trials. The lack of rigorous data that is found in formal experimental-design studies results in a greater barrier for such articles to overcome during a peer-review process. Such physicians who are already overburdened with clinical-practice obligations will often not persevere through the lengthy and arduous process of revising manuscripts for resubmission to different journals.

Further exacerbating the matter is the fact that insurance companies have different polices concerning reimbursement for off-label prescriptions. Generally, most insurers agree to pay for evidence-based, off-label indications, the determining factor being the level of evidentiary support.

In an article by Rahul Parikh entitled, “Help, My Prescription Pen Is Running Out of Ink: Why doctors need to keep the power to give drugs off-label,” published on the Slate website in December 2007, the author opines:

“Kids probably reap the greatest benefit from off-label prescriptions. Three-quarters of all drugs aren't approved for them, forcing pediatricians to regularly improvise. This despite the FDA's ‘pediatric rule,’ which rewards drug makers with a six-month patent extension if they do studies on kids. This sounds pretty good, but since it takes a lot more than six months of money and time to complete such research, the pediatric rule is little more than a token incentive, and most companies don't bother to take advantage of it.

Cancer patients are another big group who benefit from off-label drug use: Cancer drugs are prescribed off-label 60 percent of the time. This is essential, as Stanford oncologist Richard Miller wrote in a recent op-ed for the Wall Street Journal: ‘The off label use of cancer drugs . . . is vital to patient care and makes important new drugs available to more patients . . . with different types of cancer more quickly than could occur by requiring formal clinical testing in each kind of cancer.’”

In a journal article (Journal of Clinical Oncology, 2012 February; 30(6): 584-586) by David G. Pfister entitled, “Off-Label Use of Oncology Drugs: The Need for More Data and Then Some,” the author states:

“Although estimates vary, there is general agreement that off-label use of drugs to treat cancer is particularly common. For example, in 2005 the National Comprehensive Cancer Network estimated that 50% to 75% of drug or biologic therapy used to treat cancer in the United States was off label. The reasons are multifactorial. There is a spectrum of cancer types that may have shared biology and sensitivity to therapeutic agents and yet are different diseases in terms of the drug approval mechanism. FDA approval requires a lengthy and expensive process, even for a single disease indication. Once a drug is off patent, there is little enthusiasm in pharmaceutical circles to invest the resources to expand the labeled indications for an agent. Pediatric oncology and rare cancers pose special challenges to the traditional drug-approval paradigm. Given the worrisome prognosis and potentially life-threatening nature of a cancer diagnosis, particularly when recurrent or metastatic, time is critical, and discussions of risks versus benefits differ from many other disease settings.”

In an article by Robert H. Pritchard entitled, “Off-label Uses of Approved Drugs: A New Compromise is Needed,” published on the Harvard Law School website, the author opines:

“Simply stated, off-label drug uses are a medical necessity in a world where patients and strains of diseases often vary only slightly from one another, such that established treatments must be tailored to meet individual needs. Countering this need for flexibility, however, is the necessity of public protection from unsafe and ineffective drugs. For every piece of anecdotal evidence showing a death that could have been avoided if a particular drug or instrument had been available, there is a similarly compelling example of a situation in which a patient has died needlessly at the hands of an ineffective physician or method of treatment.”

In a journal article (Pharmacy & Therapeutics, 2009 August; 34(8): 428-440) by C. Lee Ventola entitled, “Off-label Drug Information: Regulation, Distribution, Evaluation, and Related Controversies,” the author opines:

“An additional important argument is that because the FDA approval process is so complex, costly, and time-consuming, the distribution of off-label drug information provides physicians and patients with early notification about novel treatments. Even with the advent of the fast-track approval process, the regulatory process is often considered to be unable to keep up with advances in medicine. The approval of an off label use of rituximab (Rituxan) for cancer treatment reportedly took four years. Proponents also point out that some off-label treatments have already been validated by high-quality independent research conducted outside of the FDA regulatory process that indicates immense benefit to patients. Supporters contend that if patients had to wait for use-specific FDA approval to be alerted about off-label treatments, many would lose the opportunity to benefit from innovations that are continuously developed in clinical practice. For example, aspirin was widely prescribed to reduce the risk of heart attacks long before the FDA approved it for this purpose in 1998.”

The U.S. Food and Drug Administration provides the following policy statement on off-label publishing:

“FDA does recognize, however, the important public health and policy justification supporting dissemination of truthful and non-misleading medical journal articles and medical or scientific reference publications on unapproved uses of approved drugs and approved or cleared medical devices to healthcare professionals and healthcare entities.”

Off-Label Ltd provides a website portal that allows registered users to search its database for compounds, diseases, disorders, journal articles, and clinical trials relevant to off-label use. Off-Label Ltd only provides access to already published research, not research that has not previously been published. As described above, medical prescribers are not always successful at publishing their research, and many case studies go unnoticed. There is also no indication that any of the material available from Off-Label Ltd is peer-reviewed for scientific worthiness.

It would be desirable to have methods for providing an off-label medical use portal. Such methods would, inter alia, overcome the various limitations mentioned above and provide a marketplace for the untapped market sector of practitioners (including subscribers, providers, prescribers, and sponsors) of off-label use of pharmaceuticals, medical devices, and medical diagnostics that is not being served. It would further be desirable to provide credibility to off-label use proposals.

### SUMMARY OF THE INVENTION

The present invention provides for an off-label medical use portal, including a centralized database encoded on a computer readable-medium, and a collecting mechanism for collecting information regarding off-label medical use, a peer-review mechanism for vetting collected information, and an access mechanism for providing access to the vetted information in electronic communication with the centralized database.

The present invention also provides for a method of using the off-label medical use portal by submitting publications about off-label medical use to the portal, peer-reviewing the publications, and providing access to peer-reviewed publications to interested individuals.

### DESCRIPTION OF THE DRAWING

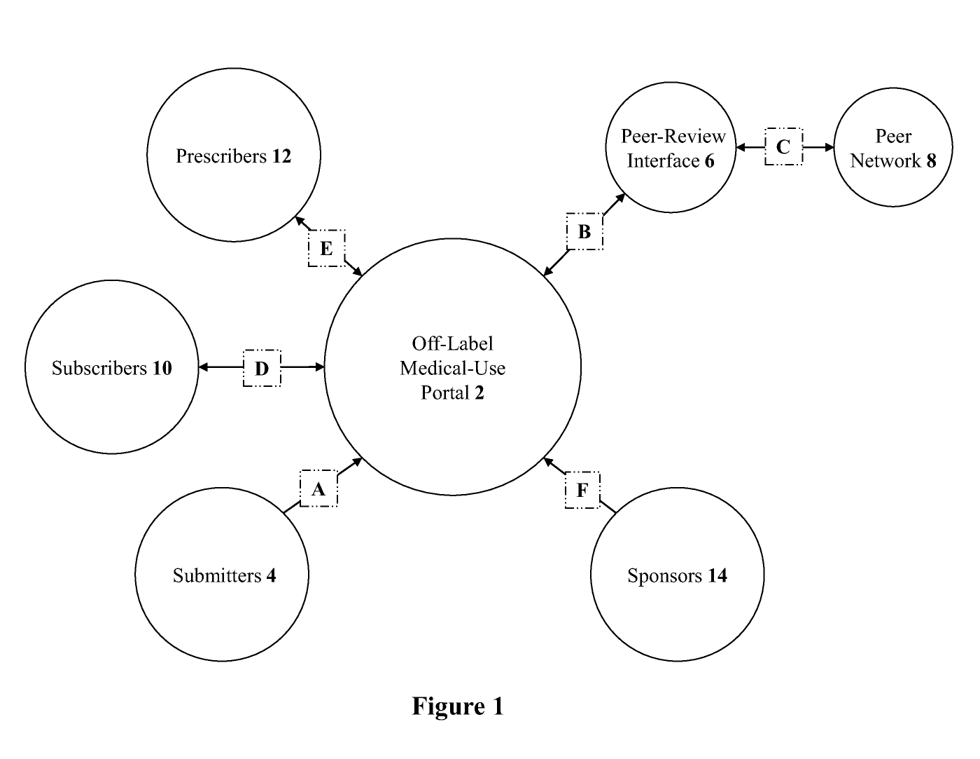

Other advantages of the present invention are readily appreciated as the same becomes better understood by reference to the following detailed description when considered in connection with the accompanying drawings wherein FIG. 1 is a schematic block diagram of information flow in the Off-Label Medical Use Portal.

### DETAILED DESCRIPTION OF THE INVENTION

The present invention generally provides for an off-label medical use portal that connects submitters, subscribers, sponsors, and peer-reviewers and collects information regarding off-label medical use with a collection mechanism, vets the collected information with a peer-review mechanism, and provides access to unvetted and vetted information in a centralized database with an access mechanism, all of which are in electronic communication with the portal and databases therein.

The term “off-label medical use” is used herein to refer to off-label use of pharmaceuticals, medical devices, and medical diagnostics.

The term “submitters” is used herein to refer to parties who seek to provide information regarding off-label medical use. The submitters can include medical practitioners, manufacturers, researchers, or others who are involved in off-label use. The submitters can provide both technical professional information regarding their project for peer review and for other users who understand such technical information, as well as simplified information for non-technical users of the portal. This allows interested individuals (such as sponsors) to understand the off-label use even if they are not technically versed in that particular field of research. Also, information is not marketed by drug companies within the portal, so no illegal marketing of off-label use occurs.

The term “subscribers” is used herein to refer to parties who seek access to information regarding off-label medical use. In that sense, the term “practitioners” in general is understood herein to be included within the definition of subscribers. Subscribers can also include individuals interested in treatment for themselves or others, industry individuals, information brokers, pharmaceutical companies, biotech companies, medical device companies, orphan disease groups, governmental and non-governmental organizations, search engines, and libraries.

The term “prescribers” is used herein to refer to medical practitioners who prescribe treatment indications. Similar to practitioners, prescribers are also within the category of subscribers, albeit a specific subset thereof.

The term “sponsors” is used herein to refer to parties who support activities associated with the off-label medical use (e.g., individuals associated with publication support, research funding, patent protection, investment solicitation, marketing, and commercialization endeavors). Such entities can include private backers, corporate investors, industry partners, nonprofit endowments, governmental agencies, advertisers, venture capitalists, patent agents/attorneys, law firms and various fund managers. By having access to the off-label medical use portal, the sponsors can gain early access to information prior to publication, i.e. immediately after submission (and before peer-review), for their advantage. The value of this information can be much higher pre-publication. For example, if no intellectual property (IP) has been filed for a particular new use described in a manuscript, patent attorneys can solicit potential clients. If IP has been filed, industry has a potential candidate for licensing.

As shown in FIG. 1, the off-label medical use portal 2 provides a submission mechanism and venue to submitters 4 for publication that is singularly focused on off-label medical use in order to collect publications within the off-label medical use portal 2. Submitters 4 can upload their manuscripts to the off-label medical use portal 2. Remuneration for publication of manuscripts is provided via off-label medical use portal 2 through Transaction Process A. Such “transaction processes” are functional steps which can be performed with human intervention, but are always operationally implemented through a computerized network system. Any remuneration can be provided electronically. Submitters 4 can include various forms of information in their manuscripts such as, but not limited to, a listing of professional credentials, previous experiences with off-label use, and motivation for using a drug or device for off-label use.

Manuscripts of submitters 4 are assessed for scientific integrity through a peer-review mechanism, i.e. a peer-review interface 6, which enables a peer network 8 (i.e. peer reviewers, preferably scientists and researchers specialized in different areas of medicine) to administer the peer-review process effectively and efficiently. Transaction Process B provides for such administration as peer categorization, peer selection, manuscript dissemination, review anonymity, review feedback input and communication, and version tracking. Because the off-label medical use portal 2 acts as a centralized access hub to innovations in off-label use, Transaction Process C attracts the most suitable candidates to serve in peer network 8. During the peer-review, an initial review can be performed by an in-house physician or researcher to ensure a manuscript meets certain criteria. The initial review can also include verification of submitter credentials and ensuring any legal conditions have been accepted. Next, the manuscript can be forwarded to peer reviewers in the peer network 8 in the specific field of the manuscript who can critique the manuscript or trial design. The peer network 8 can rank manuscripts according to which off-label use is most likely to provide results and this ranking can be listed on the portal. Alternatively, if a manuscript is deemed not scientifically sound or there are questions regarding the off-label use findings, the peer network 8 can deny its listing on the portal. While a manuscript can have a separate peer-review outside of the portal before submission, preferably manuscripts have not had any peer-review before submission and the peer network 8 is used. A manuscript will not be accessible to subscribers 10 until peer-review has taken place with the peer network 8. Limited information about a manuscript can be available to the sponsors 14 prior to peer-review and not contingent on the peer-review results. This allows sponsors 14 to solicit the submitters 4 for various services (such as IP and licensing) so that these services can be taken advantage of as early as possible before publication within the portal. Therefore, even submitters 4 who submit manuscripts that are rejected by the peer network 8 can still benefit from using the portal 2.

The peer-review mechanism can also be automated at any point, so that a manuscript can be automatically sent to a particular peer network 8 in that field of medicine. For example, based on certain key words within the manuscript or within a certain field, the manuscript can be sent to a particular peer network 8. This allows for the unexpected results of much quicker access to manuscripts by subscribers 10 and sponsors 14 through the portal 2 and quicker publication of the manuscripts such that the public has access and can obtain use from the manuscripts. This provides patients seeking treatment access to options for off-label use of medicines faster than previously.

Once a manuscript has successfully been peer-reviewed, it can be stored and accessed on the off-label medical use portal 2. Essentially, the off-label medical use portal 2 includes a database that stores each of the manuscripts (i.e. publications) that have been peer-reviewed. The collection mechanism includes both the submission of publications by submitters 4 and the reviewing of publications by the peer network 8. This step can also be automated such that once the peer network 8 indicates that the manuscript is ready to be accessed on the portal 2, it is automatically published on the portal 2 as an uncorrected proof.

Subscribers 10 engage off-label medical use portal 2 in order to obtain access to publications (i.e., peer-reviewed manuscripts) supplied by submitters 4 containing information regarding innovations in off-label use. Similarly, prescribers 12 (much like subscribers 10) seek access to off-label medical use portal 2 in order to enhance administration of patient care and to explore alternative treatment options. As some information can be pre-publication or confidential, access to this information can require subscribers 10, prescribers 12, and sponsors 14 to sign non-disclosure agreements (NDA5), which can be automated within the portal. For example, a title of a proposal can be viewed, but in order to view further details, an electronic NDA must be signed and completed before access is granted. Remuneration for such access is provided via off-label medical use portal 2 through Transaction Processes D and E. In other words, subscribers 10 can pay a fee (such as, but not limited to, a one time fee, a weekly fee, a monthly fee, or a yearly fee) in order to access the information on the portal. Any of the above steps can be automated.

Sponsors 14 engage off-label medical use portal 2 for a host of reasons depending on the type of stakeholder they are. Transaction Process F serves in part as a revenue stream (i.e. a revenue generating mechanism) for maintaining the processes described above for off-label medical use portal 2. As described above, sponsors 14 can engage in various activities and solicit submitters 4 for IP services, licensing services, publication services, investment services, marketing services, information brokerage, etc. The sponsors 14 can message the submitters 4 with a messaging mechanism in order to solicit services. Submitters 4 can optionally opt out of receiving messages from sponsors 14. Any of the above steps can be automated.

The off-label medical use portal 2 is preferably encoded and stored with computer readable memory on a central server and can be accessed electronically over the Internet. In essence, the off-label medical use portal 2 is a web-based interface and database. Access can be through an access mechanism such as a website or an application (i.e. app), and the off-label medical use portal 2 can be viewed or displayed on a screen of a computer, laptop, tablet, smart phone, smart watch, or any other device capable of accessing the Internet. Any Transaction Process or access by an individual described above can be recorded in a database in order to keep track of use and provide statistics and reports. Any information or publication in the portal can be printed at any time, and reprints can be made for industry. These prints provide a technical effect of a tangible object available to users of the portal.

The off-label medical use portal 2 can provide a search mechanism to search for any peer-reviewed publication in the database. The search mechanism can use search terms such as, but not limited to, diseases, conditions, drugs, devices, uses, submitter names, peer network names, date, and subject.

The off-label medical use portal 2 can also provide alerts to any of the users regarding activity and publications within the off-label medical use portal 2. For example, alerts can be sent to peer network 8 when a submitter 4 has sent a relevant publication to the portal 2. Subscribers 10, prescribers 12, and sponsors 14 can also receive alerts if a publication of interest (such as regarding a certain medicine, a certain disease or condition) has been published on the portal 2. Sponsors 14 can also receive alerts upon submission of a manuscript before peer-review has occurred. Alerts can be in the form of text messages, screen alerts on a smart phone or tablet, emails, sounds, RSS feed, or any other suitable type of alert. These alerts are technical effects that can prompt a user of the portal 2 to take an action.

The off-label medical use portal 2 can further include social media mechanisms that can promote dissemination of information concerning off-label use within the law, such as, but not limited to, FACEBOOK™ and TWITTER™. Submitters 4, subscribers 10, and sponsors 14 can each use the social media mechanisms to promote access to off-label manuscripts they are interested in, or request more information be provided for certain diseases or conditions.

The present invention provides for a method of using the off-label medical use portal by submitting publications about off-label medical use to the portal, peer-reviewing the publications, and providing access to peer-reviewed publications and non peer-reviewed information to interested individuals.

More specifically, the submitters submit publications (i.e. manuscripts) about off-label medical use to the portal, and the peer network reviews the publications in the peer-review interface. When the peer network finds that the publication is scientifically sound, the publication can then be accessed by the subscribers, prescribers, and sponsors on the off-label medical use portal. Sponsors can also access limited information about the manuscripts before peer-review has occurred in order to provide services to submitters as described above. Remuneration can be provided to submitters and the peer network as an incentive to submit publications and review publications. Subscribers, prescribers, and sponsors can pay to gain access to the off-label medical use portal; however, subscribers and prescribers can alternatively access the portal for free. As described above, statistics and reports can be generated, and alerts can be generated.

The present invention provides several advantages. The off-label medical use portal is a venue for publication that is singularly focused on off-label (ex-indication) medical use. The off-label medical use portal enables reports and manuscripts related to off-label medical uses to be submitted, emphasizing the non-regulatory approved nature of such usage of pharmaceuticals, devices, and diagnostics as the focus. The present invention further provide practitioners in pharmaceutical and biotech industries a centralized access hub to innovations in off-label medical use, while saving search and transaction costs, particularly time with regard to innovation, implementation, and commercialization. Such an access hub further spearheads the clinical implementation of such therapies by educating prescribers, and providing pertinent information to pharmaceutical companies effectively and efficiently. The present invention also allows for access to manuscripts that have been vetted by a peer-review network and not necessarily published, allowing peer-reviewed information to reach interested individuals in a short amount of time. The present invention further allows sponsors access to non-peer-reviewed information, and such access results in the ability to file for IP protection, such possibility being lost once manuscript is published. Currently, there is no option for this service with current portals or journals, hence many authors who are unaware of ability to file for IP protection lose their rights through public disclosure. This is an unexpected step because medical journals are bound by extreme levels of trust not to publicize any information prior to publication. The very notion of selectively sharing information pre-publication is unexpected, and the present invention provides advantages for submitters to gain access to services available by the sponsors.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. An off-label medical use portal, comprising a centralized database encoded on a computer readable-medium, and collecting means for collecting information regarding off-label medical use, peer-review means for vetting collected information, and access means for providing access to unvetted information and said vetted information in electronic communication with said centralized database.

2. The off-label medical use portal of claim 1, wherein said off-label medical use portal connects submitters, subscribers, sponsors, and peer-reviewers.

3. The off-label medical use portal of claim 2, wherein said collecting means is further defined as a submission mechanism that collects publications from said submitters.

4. The off-label medical use portal of claim 3, wherein said peer-review means includes a peer-review interface enabling said peer network to peer-review said publications.

5. The off-label medical use portal of claim 4, wherein said peer-review interface provides an administration function chosen from the group consisting of peer categorization, peer selection, manuscript dissemination, review anonymity, review feedback input and communication, version tracking, and combinations thereof.

6. The off-label medical use portal of claim 2, wherein said access means provides access of peer-reviewed publications to said subscribers and sponsors, and provides access of non-peer-reviewed information to said sponsors.

7. The off-label medical use portal of claim 2, wherein said subscribers are further defined as prescribers that administer patient care.

8. The off-label medical use portal of claim 2, further including a revenue generating mechanism from said sponsors.

9. The off-label medical use portal of claim 2, wherein said off-label medical use portal is accessible over the Internet through a mechanism chosen from the group consisting of a website and an application.

10. The off-label medical use portal of claim 2, wherein said off-label medical use portal is viewed on a device chosen from the group consisting of a computer, laptop, tablet, smart phone, and smart watch.

11. The off-label medical use portal of claim 2, further including a tracking mechanism for tracking use of said off-label medical use portal, a statistics mechanism, and a reporting mechanism in electronic communication with said off-label medical use portal.

12. The off-label medical use portal of claim 2, further including search means for searching said peer-reviewed publications.

13. The off-label medical use portal of claim 2, further including alert means for alerting a user regarding activity within said off-label medical use portal.

14. The off-label medical use portal of claim 2, further including remuneration means for providing remuneration to said submitters and peer-reviewers and generating remuneration from said subscribers.

15. A method of using an off-label medical use portal, including the steps of:
submitting publications about off-label medical use to the off-label medical use portal;
peer-reviewing the publications; and
providing access to non-peer reviewed information and peer-reviewed publications to interested individuals.

16. The method of claim 15, wherein the interested individuals are chosen from the group consisting of subscribers, sponsors, and combinations thereof.

17. The method of claim 15, wherein said peer-reviewing step further includes a step chosen from the group consisting of peer categorizing, peer selecting, manuscript disseminating, providing review anonymity, providing review feedback input and communication, providing version tracking, and combinations thereof.

18. The method of claim 15, further including the step of accessing the off-label medical use portal through the Internet by a mechanism chosen from the group consisting of a website and an application.

19. The method of claim 15, further including the step of displaying the off-label medical use portal on a device chosen from the group consisting of a computer, laptop, tablet, smart phone, and smart watch.

20. The method of claim 15, further including the step of generating revenue from the sponsors.

21. The method of claim 15, further including the step of providing remuneration to submitters submitting publications and peer-reviewers peer-reviewing the publications.

22. The method of claim 15, wherein said providing access step further includes the step of collecting payment from subscribers and sponsors to gain access to the off-label medical use portal.

23. The method of claim 15, further including the step of providing statistics and reports of use of the off-label medical use portal.

24. The method of claim 15, wherein said providing access step further includes the step of searching for peer-reviewed publications.

25. The method of claim 15, further including the step of alerting a user of the off-label medical use portal regarding a publication.
